(19) United States
(12) Patent Application Publication
(10) Pub. No.: US 2021/0229418 A1
(43) Pub. Date: Jul. 29, 2021

(54) TRANSFER MEMBER, INK JET RECORDING METHOD, AND INK JET RECORDING APPARATUS

(71) Applicant: CANON KABUSHIKI KAISHA, Tokyo (JP)

(72) Inventors: Tsukasa Sano, Kanagawa (JP); Akira Goto, Kanagawa (JP); Yukari Sumioka, Kanagawa (JP); Yoshikazu Saito, Tokyo (JP); Tetsuya Kosuge, Kanagawa (JP); Mitsutoshi Noguchi, Kanagawa (JP); Yuichiro Kanasugi, Tokyo (JP); Midori Kushida, Tokyo (JP)

(21) Appl. No.: 17/151,929

(22) Filed: Jan. 19, 2021

(30) Foreign Application Priority Data
Jan. 27, 2020 (JP) 2020-011007
Dec. 23, 2020 (JP) 2020-213731

(51) Int. Cl. B41J 2/005; B41J 2/01

(52) U.S. Cl. CPC B41J 2/0057; B41J 2002/012; B41J 2/01

(57) ABSTRACT

A transfer member according to the present invention includes a base layer and a surface layer, wherein a swelling rate of the surface layer by 1,2-hexanediol is 5% or less, and a storage elastic modulus of the surface layer is 30 MPa or more to 250 MPa or less.

### BACKGROUND OF THE INVENTION

### Field of the Invention

The present invention relates to a transfer member, and an ink jet recording method and an ink jet recording apparatus using such a transfer member.

### Description of the Related Art

A transfer type ink jet recording method in which an ink is applied to an image formation surface of a transfer member by an ink jet method to form an image, the image is transferred to a recording medium from the image formation surface of the transfer member to record the image on the recording medium is known. In addition, a method of applying a reaction liquid (also referred to as a treatment liquid) that reduces fluidity of an ink to an image formation surface of a transfer member to hold the ink on the transfer member without flowing of the ink applied to the image formation surface of the transfer member is also proposed. The image formation surface of the transfer member used for the image formation by the ink and the reaction liquid is required to have wettability suitable for the image formation by the ink and the reaction liquid and transferability (image releasability) of the image to the recording medium. Furthermore, the image formation surface of the transfer member is required to have cleanability so that the wettability and the transferability can be repeatedly used. Several methods of cleaning a transfer member to repeatedly provide an optimal image formation surface have been proposed so far. Japanese Patent Application Laid-Open No. 2006-224493 discloses a method of covering a printing blanket and a blanket cylinder constituting a transfer member by a sealing structure and monitoring the amount of swelling of the blanket with an ink by a sensor. Therefore, the amount of swelling can be kept constant when the blanket is repeatedly used. Japanese Patent Application Laid-Open No. H06-143858 proposes a printing blanket which is a transfer member, the blanket including a reinforcement layer formed of a polymer material and having a plurality of holes, a sponge-like pressure absorbing layer, and a core material under a silicone rubber layer thereof. Therefore, an organic solvent in an ink absorbed in the silicone rubber layer passes through the plurality of holes formed in the reinforcement layer and is absorbed in the sponge layer. Thus, swelling of the silicone rubber layer can be suppressed. As in Japanese Patent Application Laid-Open No. 2006-224493 and Japanese Patent Application Laid-Open No. H06-143858, the image formation surface of the transfer member on which the image formation is performed using a material containing a plurality of elements such as an organic solvent and a resin is required to be stably swollen with a solvent or the like or to have cleanability so as to be returned to a non-swollen state. In particular, in a case where a ratio of a component such as an ink is important when performing image formation or transfer, it is considered that a surface of a transfer member is desirably returned to an initial state in which the surface is not swollen in order not to change the ratio of the component.

### SUMMARY OF THE INVENTION

An object of the present invention is to provide a transfer member having improved image formability, transferability, and cleanability during repeated use. In addition, another object of the present invention is to provide an ink jet recording method and an ink jet recording apparatus using the transfer member.

According to an aspect of the present invention, there is provided a transfer member including a base layer and a surface layer, wherein a swelling rate of the surface layer by 1,2-hexanediol is 5% or less, and a storage elastic modulus of the surface layer is 30 MPa or more to 250 MPa or less.

Further, according to another aspect of the present invention, there is provided an ink jet recording method including: applying a reaction liquid containing a component that increases a viscosity of an ink to an image formation surface of a transfer member; applying an ink to the image formation surface of the transfer member to form an ink image; and transferring the ink image from the transfer member to a recording medium, wherein the transfer member includes a base layer and a surface layer, a swelling rate of the surface layer by 1,2-hexanediol is 5% or less, and a storage elastic modulus of the surface layer is 30 MPa or more to 250 MPa or less.

Further, according to still another aspect of the present invention, there is provided an ink jet recording apparatus including: an image forming unit that includes a reaction liquid applying device applying a reaction liquid containing a component that increases a viscosity of an ink to an image formation surface of a transfer member, and an ink applying device applying an ink to the image formation surface of the transfer member to form an ink image; and a transfer unit that transfers the ink image from the transfer member to a recording medium, wherein the transfer member includes a base layer and a surface layer, a swelling rate of the surface layer by 1,2-hexanediol is 5% or less, and a storage elastic modulus of the surface layer is 30 MPa or more to 250 MPa or less.

Further features of the present invention will become apparent from the following description of exemplary embodiments with reference to the attached drawings.

### BRIEF DESCRIPTION OF THE DRAWINGS

FIG. 1 is a schematic view illustrating a configuration of a transfer member in an exemplary embodiment of the present invention.

FIG. 2 is a schematic view illustrating a configuration of an ink jet recording apparatus used in an ink jet recording method in an exemplary embodiment of the present invention.

### DESCRIPTION OF THE EMBODIMENTS

In a transfer type recording method, it is desirable that a transfer member is repeatedly used for image formation in terms of a running cost. However, the transfer member is repeatedly subjected to a step of performing image formation on the transfer member using a reaction liquid having a plurality of components such as an acid and an organic solvent, and an ink, and performing cleaning using a cleaning liquid containing a solvent component after transfer. In this case, according to studies conducted by the present inventors, a surface layer of the transfer member is swollen due to the used component such as the solvent, and the original image formability or transferability may be impaired. In addition, in a case where a treatment for keeping the amount of swelling of the surface layer constant is performed as described in Japanese Patent Application Laid-Open No. 2006-224493, an optimum ratio of the component may be impaired due to mixing with the swollen solvent. Meanwhile, in a case where the blanket in which the sponge layer is provided to eliminate swelling of a surface layer is used as in Japanese Patent Application Laid-Open No. H06-143858, when continuous printing is performed, the sponge layer formed under the surface layer is in a swollen and saturated state, even though there is no problem with the initial image formability or transferability. Accordingly, the swelling of the surface layer is not suppressed in substance.

Therefore, the present inventors conducted intensive studies to improve image formability, transferability, and cleanability when the surface layer is repeatedly used, thereby completing the present invention.

Hereinafter, the present invention will be described in detail with reference to preferred exemplary embodiments. The preferred exemplary embodiments will be described by using a transfer type ink jet recording method, but the present invention is not limited to the transfer type ink jet recording method. That is, in a recording process of repeatedly applying a liquid containing an organic solvent to a transfer member, a material of the surface layer used in the present invention is effective.

The transfer member according to the present invention includes a base layer and a surface layer. The surface layer has an image formation surface, and an ink image is formed on the image formation surface by an ink. The ink image formed on the transfer member may be referred as an intermediate image. Then, the intermediate image is transferred to a recording medium to form the ink image on the recording medium. Therefore, the transfer member may be referred to as a transfer type recording transfer member.

It is important for the image formation surface of the transfer member (a surface of the transfer member) to have surface properties that achieve both excellent ink image formation and transfer of the ink image to the recording medium. In order to form a high-quality ink image on the transfer member, it is preferable that the image formation surface has wettability that enables uniform application of a reaction liquid containing a component that increases a viscosity of an ink. On the other hand, in a case where the image formation is repeatedly performed by using the same transfer member, it is preferable that the image formation surface of the transfer member is not swollen even though the reaction liquid, the ink, and the cleaning liquid are repeatedly applied.

The present inventors conducted studies on physical properties of the image formation surface of the transfer member, and found that an increase in amount of swelling of the surface layer having the image formation surface is a factor in disturbing stable image formation and transfer during continuous printing. That is, when the image formation is performed in a state where the surface layer is swollen due to any one of the components contained in the reaction liquid, the ink, and the cleaning liquid, a limited ratio of the component in the reaction liquid or the ink is changed, and thus, a high-quality ink image cannot be formed. In addition, the solvent component remains on the surface layer, which causes a transfer residue during transfer and poor formation of the intermediate image.

The present inventors conducted studies on an influence of the swelling on the image formability and the transferability, and have clarified that a swelling rate of the surface layer by 1,2-hexanediol is an index for measuring the image formability and the transferability. Here, the used 1,2-hexanediol is a solvent that is also contained in the ink as the component. In addition, the 1,2-hexanediol is used as a representative moisturizing ingredient in cosmetics and is known as a solvent that easily causes swelling.

The present inventors conducted studies on a range of the swelling rate of the surface layer by the 1,2-hexanediol required to satisfy each of the image formability and the transferability described above during continuous printing (that is, during repeated use). Then, the present inventors found that the transfer member can satisfy each of the image formability and the transferability described above by controlling the surface layer of the transfer member within an appropriate swelling rate. The present invention is based on the findings of the present inventors. In the present invention, the image formability, the transferability, and the cleanability are improved by controlling the swelling rate of the surface layer by the 1,2-hexanediol to 5% or less. By adjusting the material of the surface layer of the transfer member to obtain the swelling rate in this range, a high-quality ink image formed on the transfer member can be obtained, and the ink image can be transferred to the recording medium with high transferability, even during repeated use. In addition, the reaction liquid, the ink, or the cleaning liquid does not easily swell inside the surface layer, such that the transfer member can be returned to the initial state with high cleanability. In addition, when a storage elastic modulus of the surface layer of the transfer member is 30 MPa or more to 250 MPa or less, the image formation surface can withstand abrasion during transfer in continuous printing, and the transfer member can follow the recording medium during transfer, which can improve the transferability.

Hereinafter, the present invention will be described in detail with reference to preferred exemplary embodiments. An ink jet recording apparatus including a transfer member is hereinafter sometimes referred to as a transfer type ink jet recording apparatus for convenience, and an ink jet recording method using a transfer member is hereinafter sometimes referred to as a transfer type ink jet recording method for convenience. In addition, a transfer type ink jet recording transfer member is sometimes simply referred to as a transfer member.

Transfer Member

The transfer member according to the present invention includes at least a surface layer having an image formation surface. In addition, the transfer member further includes, for example, a base layer for imparting to the transfer member strength required for handling or fixing to a transfer part.

The base layer is not particularly limited as long as it can support the surface layer having the image formation surface and impart required mechanical strength or physical properties to the transfer member, and the base layer preferably includes at least one layer of an elastic layer, a compression layer, and a reinforcement layer. The base layer may be formed of a plurality of layers. The base layer formed of the plurality of layers may have a structure obtained by producing respective layers and adhering the layers to each other by an intermediate layer such as an adhesion layer, or may have a stacked structure obtained by previously preparing or forming a layer and forming and integrating a subsequent layer thereon. Alternatively, the base layer may have both the two structures.

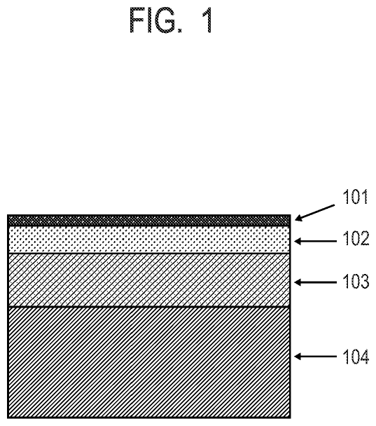

FIG. 1 schematically illustrates a configuration of the transfer member according to the present exemplary embodiment as a partial cross-sectional view in a thickness direction. The illustrated transfer member has a structure in which a surface layer 101, an elastic layer 102 as a base layer, a compression layer 103, and a reinforcement layer 104 are stacked in this order. The elastic layer, the reinforcement layer, and the compression layer may be integrated.

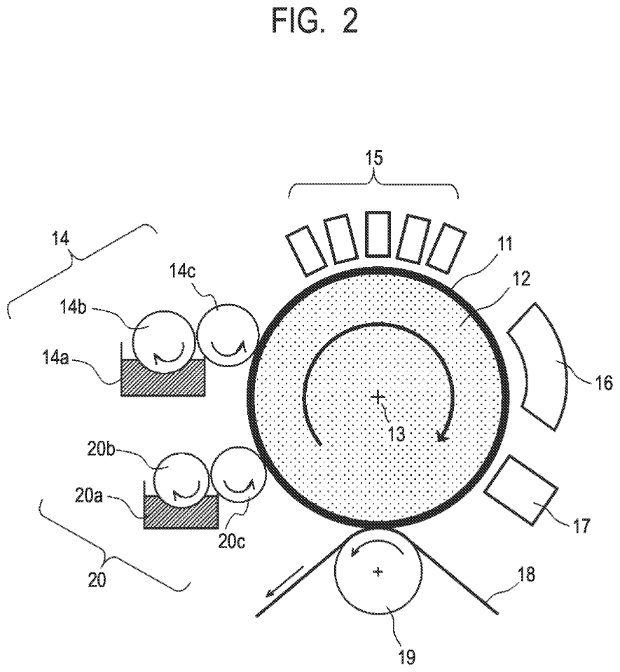

Examples of a shape of the transfer member can include a sheet shape, a roller shape, a drum shape, a belt shape, and an endless web shape. In addition, a size of the transfer member can be appropriately set according to a size of the recording medium or the like. In particular, when a drum-shaped transfer member as in an exemplary embodiment of FIG. 2 is used, continuous and repeated use of the same transfer member is facilitated and a preferred configuration is achieved also from the viewpoint of productivity.

Support Member

A support member can be used, if necessary, to impart a conveyance property and mechanical durability to the transfer member. The support member supports a surface opposite to a surface of the surface layer of the transfer member (a surface of the reinforcement layer 104).

The support member is required to have strength to some extent from the viewpoint of the conveyance accuracy and durability. As a material of the support member, a metal, ceramics, a resin, or the like is preferred. Specifically, aluminum, iron, stainless steel, an acetal resin, an epoxy resin, polyimide, polyethylene, polyethylene terephthalate, nylon, polyurethane, silica ceramics, or alumina ceramics is preferred. When the support member is formed of a material selected from these materials, rigidity or dimension accuracy that can withstand pressurization during transfer can be secured, and inertia during operation can be reduced to enhance control responsiveness. These materials can be used alone or in combination of two or more thereof.

A shape or structure of the support member may be set so that the transfer member can be supported, and is not particularly limited. For example, the shape of the support member can be any shape such as a roller shape, a drum shape, or a belt shape according to a form of an ink jet recording apparatus to which the transfer member is applied, a transfer mode to the recording medium, the shape of the transfer member, and the like. An ink jet recording apparatus illustrated in FIG. 2 described below is provided with a transfer member on an outer circumferential surface of a drum-shaped support member.

Reinforcement Layer

The reinforcement layer can be used to improve conveyance accuracy and mechanical durability of the transfer member. The reinforcement layer comes into contact with the support member. The reinforcement layer 104 is required to have strength to some extent from the viewpoint of the conveyance accuracy and durability. The reinforcement layer 104 can be formed of a fabric, a film, a sheet, or the like. Examples of a material of the fabric can include cotton, polyester, polyimide, and nylon. Examples of a material of the film can include polyethylene terephthalate and polyimide. A thickness of the reinforcement layer is not particularly limited, and may be set so that a reinforcement layer having a desired reinforcing function can be obtained. For example, the thickness of the reinforcement layer is preferably 0.1 mm or more to 1.5 mm or less. In addition, the transfer member may further include a reinforcement layer (also referred to as a second reinforcement layer) between the compression layer and the elastic layer, in addition to the reinforcement layer (also referred to as a first reinforcement layer) coming into contact with the support member.

Compression Layer

The compression layer 103 can be used to homogenize the pressure (transfer pressure) applied to the transfer member during transfer. The compression layer 103 preferably has rubber (sponge rubber) having voids. Here, the void may be composed of an open cell or a closed cell, but a closed cell is preferred from the viewpoint of a recovery property from deformation of the compression layer due to the transfer pressure. Polybutadiene-based rubber, nitrile-based rubber, chloroprene-based rubber, silicone-based rubber, fluoro rubber, fluorosilicone-based rubber, or urethane-based rubber is preferred as the rubber. A styrene-based elastomer, an olefin-based elastomer, a vinyl chloride-based elastomer, an ester-based elastomer, and an amide-based elastomer are preferred as other rubbers. These rubbers can be used alone or in combination of two or more thereof to form the compression layer. In order to more effectively obtain a suitable deformation state, a thickness of the compression layer is preferably 0.1 mm or more to 2.0 mm or less, and more preferably 0.2 mm or more to 2.0 mm or less, from the viewpoint of homogenization of the transfer pressure and suppression of distortion of the transfer member in a movement direction during transfer.

Elastic Layer

The elastic layer 102 can be used to improve followability of the transfer member to the recording medium. As materials forming the elastic layer 102, various materials such as a resin, an elastomer, rubber, and ceramics can be appropriately used. These materials can be used alone or in combination of two or more thereof.

Various elastomers and various rubbers are preferred in terms of a processing property or the like. Specific examples of the rubber can include silicone rubber, fluoro rubber, chloroprene rubber, urethane rubber, nitrile rubber, ethylene propylene rubber, and natural rubber. Specific examples of the other rubbers can include styrene rubber, isoprene rubber, butadiene rubber, ethylene-propylene-diene rubber, and nitrile butadiene rubber (acrylonitrile-butadiene rubber). These materials can be used alone or in combination of two or more thereof. In particular, silicone rubber, fluoro rubber, or ethylene-propylene-diene rubber is preferred in terms of transferability because a change in elastic modulus due to a temperature is small. Accordingly, the surface layer is preferably formed of at least one of acrylonitrile-butadiene rubber, silicone rubber, fluoro rubber, and ethylene-propylene-diene rubber. Furthermore, the surface layer is more preferably formed of at least one of silicone rubber, fluoro rubber, and ethylene-propylene-diene rubber.

The elastic layer preferably contains the resin, ceramics, and rubber in a total amount of 10% by mass or more to 100% by mass or less based on a total mass of the elastic layer. In addition, the resin, ceramics, and rubber are more preferably contained in the total amount of 30% by mass or more, and still more preferably contained in the total amount of 50% by mass or more. The elastic layer may contain various fillers or additives other than the above materials.

A compressive elastic modulus E2 of the elastic layer is 0.5 MPa or more to 50 MPa or less. In addition, the compressive elastic modulus E2 of the elastic layer is more preferably 3.0 MPa or more to 25.0 MPa or less, and particularly preferably 5.0 MPa or more to 25.0 MPa or less. When the compressive elastic modulus E2 is 0.5 MPa or more, a large deformation of the elastic layer is suppressed, and the surface layer easily follows the deformation of the elastic layer. When the compressive elastic modulus E2 is 50.0 MPa or less, in particular, stress locally applied to the surface layer at a high speed can be sufficiently relieved at the elastic layer, and crack resistance and transferability can be improved.

A thickness of the elastic layer is preferably 0.05 mm or more to 0.5 mm or less from the viewpoint of more effectively exhibiting the function of the elastic layer. An upper limit of the thickness of the elastic layer is more preferably 0.2 mm or less.

Surface Layer

The surface layer 101 has a function as a layer having an image formation surface for forming an ink image. The image formation surface is provided on at least one part of an opening surface of the surface layer 101 (a surface opposite to a surface in contact with the elastic layer 102). A contact angle of water of the image formation surface is preferably 85° or more to 110° or less to obtain surface properties suitable for formation of the ink image and transfer of the ink image to the recording medium.

As a material of the surface layer, a metal, ceramics, a resin, or the like is preferred. Specifically, polybutadiene-based rubber, nitrile-based rubber, chloroprene-based rubber, silicone-based rubber, fluoro rubber, fluorosilicone-based rubber, or urethane-based rubber is preferred. In addition, a styrene-based elastomer, an olefin-based elastomer, a vinyl chloride-based elastomer, an ester-based elastomer, an amide-based elastomer, polyether, polyester, polystyrene, polycarbonate, a siloxane compound, or a perfluorocarbon compound is preferred. In addition, the surface layer may be formed by stacking a plurality of materials. Examples of the material can include a material obtained by stacking silicone rubber on a urethane rubber sheet, a material obtained by stacking silicone rubber on a polyethylene terephthalate film, and a material obtained by forming a film of a siloxane compound on a urethane rubber sheet. In particular, the surface layer 101 of the transfer member of the present invention is preferably formed of a condensate obtained by condensing an organosilane compound in terms of achieving both ink image formability and transferability.

Examples of the organosilane compound for obtaining the condensate can include a hydrolyzable organosilane compound having a non-hydrolyzable alkyl group and a hydrolyzable organosilane compound having a polymerizable group. A composition for forming a condensate can be obtained by using at least one organosilane compound. In particular, the surface layer preferably contains a hydrolyzable organosilane compound. By using the hydrolyzable organosilane compound having the polymerizable group, a condensate can be polymerized or crosslinked depending on a type of the polymerizable group to obtain a layer formed of the condensate having a desired hardness. In addition, it is preferable that a compound having a flexible group and a reactive group is appropriately added to impart flexibility to the condensate of the organosilane compound. When the reactive group is a photopolymerizable group, a coating liquid obtained by mixing a condensate and a photopolymerization initiator can be prepared and a coating layer can be irradiated with light, thereby obtaining a layer formed of a photo-cured product of the condensate.

An example of a hydrolyzable organosilane compound having a non-hydrolyzable hydrocarbon group for forming a condensate can include at least one compound of the following General Formula (1).

(R³⁰)ₜ—Si—(R³¹)₍₄₋ₜ₎ (1)

(wherein R³⁰ represents a non-hydrolyzable hydrocarbon group, R³¹ represents a hydrolyzable group, and t is an integer of 1 to 3.)

Examples of the non-hydrolyzable hydrocarbon group can include a saturated hydrocarbon, an alicyclic hydrocarbon, and an aromatic hydrocarbon. An example of the saturated hydrocarbon can include an alkyl group having 1 to 10 carbon atoms which may be substituted with a fluorine atom. In a case where the non-hydrolyzable alkyl group is substituted with fluorine, all hydrogen atoms of the alkyl group are preferably substituted with fluorine.

An example of the hydrolyzable group can include an alkyloxy group, and examples of the alkyl group of the alkyloxy group can include a methyl group and an ethyl group.

Specific examples of the compound of General Formula (1) can include the following compounds: methyltrimethoxysilane, methyltriethoxysilane, dimethyldimethoxysilane, dimethyldiethoxysilane, diethyldiethoxysilane, trimethylmethoxysilane, trimethylethoxysilane, propyltrimethoxysilane, propyltriethoxysilane, hexyltrimethoxysilane, hexyltriethoxysilane, decyltrimethoxysilane, decyltriethoxysilane, cyclopentylmethyldimethoxysilane, cyclopentylmethyldiethoxysilane, cyclohexylmethyldimethoxysilane, cyclohexylmethyldiethoxysilane, dicyclopentyldiethoxysilane, dicyclohexyldiethoxysilane, phenylmethyldimethoxysilane, phenylmethyldiethoxysilane, phenyltriethoxysilane, diphenyldiethoxysilane, trimethoxy(3,3,3-trifluoropropyl)silane, triethoxy(1H,1H,2H,2H-nonafluorohexyl)silane, and triethoxy-1H,1H,2H,2H-tridecafluoro-n-octyl silane.

An example of a hydrolyzable silane compound having a non-hydrolyzable polymerizable group for forming a condensate can include a compound represented by the following General Formula (2).

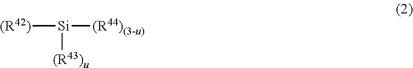

(wherein R⁴², R⁴³, and R⁴⁴ represent a non-hydrolyzable polymerizable group, a non-hydrolyzable alkyl group, and a hydrolyzable group, respectively, and u is an integer of 0 to 2.)

Example of the non-hydrolyzable polymerizable group can include a group having a vinyl group and a group having a cyclic ether group such as an epoxy group or an oxetanyl group.

An example of the non-hydrolyzable alkyl group can include an alkyl group having 1 to 10 carbon atoms.

An example of the hydrolyzable group can include an alkyloxy group, and examples of the alkyl group of the alkyloxy group can include a methyl group and an ethyl group.

Specific examples of the compound of General Formula (2) can include the following compounds:

glycidoxypropyltrimethoxysilane, glycidoxypropyltriethoxysilane, glycidoxypropyldiethoxysilane, glycidoxypropylmethyldimethoxysilane, glycidoxypropylmethyldiethoxysilane, glycidoxypropyldimethylmethoxysilane, glycidoxypropyldimethylethoxysilane, 2-(epoxycyclohexyl) ethyltrimethoxysilane, 2-(epoxycyclohexyl) ethyltriethoxysilane, and a compound in which an epoxy group of each of these compounds is substituted with an oxetanyl group; and acryloxypropyltrimethoxysilane, acryloxypropyltriethoxysilane, acryloxypropylmethyldimethoxysilane, acryloxypropylmethyldiethoxysilane, acryloxypropyldimethylmethoxysilane, acryloxypropyldimethylethoxysilane, methacryloxypropyltrimethoxysilane, methacryloxypropyltriethoxysilane, methacryloxypropylmethyldimethoxysilane, methacryloxypropylmethyldiethoxysilane, methacryloxypropyldimethylmethoxysilane, and methacryloxypropyldimethylethoxysilane.

In a case where one or more compounds of General Formulas (1) and (2) are used, a mixing ratio thereof is preferably selected from a molar ratio of 0:100 to 90:10 (the compound of General Formula (1): the compound of General Formula (2)). In particular, an organosiloxane compound is more preferably condensed at a mixing ratio (molar ratio) of 50:50 to 70:30 (the compound of General Formula (1): the compound of General Formula (2)), which can improve durability.

Examples of the flexible group of the compound having the flexible group and the reactive group can include a polyalkylene oxide (PAO) group and a linear hydrocarbon group. By adding the reactive compound having such a group, elasticity can be imparted to the condensate of organosiloxane that forms the image formation surface and durability of the image formation surface can be improved. A reactive compound having a linear hydrocarbon group as a flexible group is more preferably used because the linear hydrocarbon group is flexible and swelling resistance to a solvent is high. Either a saturated hydrocarbon group or an unsaturated hydrocarbon group can be used as the hydrocarbon group. In a case where a low swelling property is more considered than the flexibility, the saturated hydrocarbon group is more preferred. In a case where the flexibility is more considered than the low swelling property, the unsaturated hydrocarbon group is more preferred. As the reactive group referred to here, a hydroxyl group of alcohols, a hydrolyzable group of hydrolyzable siloxane, an amino group of amines, a mercapto group of thiols, or the like can be used. The linear hydrocarbon group preferably has a structure represented by the following General Formula (3) from the viewpoint of flexibility.

—(CₙH₍₂ₙ₋ₘ₎)ₚ— (3)

(n represents an integer of 1 to 7, m represents an integer of 0 to 2, and p represents an integer of 1 to 120.)

As the compound having the reactive group that imparts flexibility, it is possible to use at least one of the following compounds: 1,4-butanediol, 1-butene-1,4-diol, 1,3-butadiene-1,4-diol, 1,5-pentanediol, 2-pentene-1,5-diol, 1,3-pentadiene-1,5-diol, 1,6-hexanediol, 2-hexene-1,6-diol, 2,4-hexadiene-1,6-diol, 1,4-butanedithiol, 1-butene-1,4-dithiol, 1,3-butadiene-1,4-dithiol, 1,5-pentanedithiol, 2-pentene-1,5-dithiol, 1,3-pentadiene-1,5-dithiol, 1,6-hexanedithiol, 2-hexene-1,6-dithiol, 2,4-hexadiene-1,6-dithiol, 1,4-butanediamine, 1-butene-1,4-diamine, 1,3-butadiene-1,4-diamine, 1,5-pentanediamine, 2-pentene-1,5-diamine, 1,3-pentadiene-1,5-diamine, 1,6-hexanediamine, 2-hexene-1,6-diamine, 2,4-hexadiene-1,6-diamine, 1,4-bis(trimethoxysilyl) butane, 1,4-bis(trimethoxysilyl)-1-butene, 1,4-bis(trimethoxysilyl)-1,3-butadiene, 1,5-bis(trimethoxysilyl) pentane, 1,5-bis(trimethoxysilyl)-2-pentene, 1,5-bis(trimethoxysilyl)-1,3-pentadiene, 1,6-1,5-bis(trimethoxysilyl) hexane, 1,6-bis(trimethoxysilyl)-2-hexene, and 1,6-bis(trimethoxysilyl)-2,4-hexadiene.

In addition, the surface of the transfer member may be subjected to a surface treatment. Examples of the surface treatment can include a frame treatment, a corona treatment, a plasma treatment, a polishing treatment, a roughening treatment, an active energy ray irradiation treatment, an ozone treatment, a surfactant treatment, and a silane coupling treatment. A plurality of treatments may be used in combination.

The hydrolyzable organosilane compound for forming a condensate preferably includes at least one of the hydrolyzable organosilane compound having a perfluoroalkyl group represented by General Formula (1) and the hydrolyzable organosilane compound having an epoxy group represented by General Formula (2). The compound having the flexible group and the reactive group is preferably used in combination with the above compounds. That is, it is desirable that the image formation surface of the transfer member contains a siloxane bond and is formed of a condensate of hydrolyzable organosiloxane having an epoxy group and a condensate of organosiloxane obtained by condensing the compound having the flexible group and the reactive group. The mixing ratio of the compound having the polymerizable group that imparts flexibility is preferably selected from a molar ratio of 95:5 to 20:80 ((the compound of General Formula (1)+(the compound of General Formula (2)): the compound having the polymerizable group that imparts flexibility)).

Method of Producing Condensate

A condensation reaction for producing a condensate of an organosilane compound (organosiloxane compound) can be performed by allowing hydrolysis, if necessary, and a condensation reaction to proceed by performing heating in the presence of water. As a result, a siloxane bond is formed. An organosilane compound as a monomer for obtaining a desired condensate is selected, and if necessary, hydrolysis and the condensation reaction are appropriately controlled by a temperature, a time, a pH, and the like, such that a desired degree of condensation and surface physical properties can be obtained. In addition, an acid catalyst, an alkali catalyst, or like may also be used. A degree of progression of the condensation reaction (a degree of condensation and the number of siloxane bonds) can be defined as a ratio of the number of condensed functional groups to the number of condensable functional groups, and can be estimated by a known method such as Si-NMR measurement.

The degree of condensation varies depending on a type and synthesis condition of the organosilane compound, and a case where the degree of condensation is too low may affect coatability, film formability, and the like. Therefore, the degree of condensation is preferably 20% or more. Furthermore, the degree of condensation is more preferably 30% or more from the viewpoint of coatability and film formability. In particular, the degree of condensation is preferably controlled within a range of 50% or more to 70% or less from the viewpoint of acid resistance.

Method of Forming Surface Layer

In the present invention, the swelling rate of the surface layer by the 1,2-hexanediol is 5% or less and preferably 3% or less. The swelling rate of the surface layer can be adjusted within the above ranges by selecting a constituent material and formation method of the surface layer. In addition, in order to impart desired physical properties to the image formation surface of the surface layer of the transfer member so as to obtain the swelling rate described above, a surface (for example, the surface of the elastic layer) before the surface layer is formed may be subjected to a surface treatment. Examples of the surface treatment can include a frame treatment, a corona treatment, a plasma treatment, a polishing treatment, a roughening treatment, an active energy ray irradiation treatment, an ozone treatment, a surfactant treatment, and a silane coupling treatment. A plurality of treatments may be used in combination.

In the present invention, the storage elastic modulus of the surface layer is 30 MPa or more to 250 MPa or less. When the storage elastic modulus is 30 MPa or more, the image formation surface can withstand abrasion during transfer in continuous printing. In addition, when the storage elastic modulus is 250 MPa or less, the transfer member can follow the recording medium during transfer. A thickness of the surface layer is preferably 0.001 mm or more to 0.020 mm or less.

Ink Jet Recording Method

Image Formation Process

An image formation process includes: a reaction liquid applying step of applying a reaction liquid containing a component that increases a viscosity of an ink to an image formation surface of a transfer member; and an ink applying step of applying an ink to the image formation surface of the transfer member to form an ink image.

The application of the reaction liquid can be performed at least one of before ink application and after ink application. The ink and the reaction liquid are applied to the image formation surface of the transfer member so that they are at least partially overlapped. In order to more effectively increase the viscosity of the ink by the reaction liquid, the ink is preferably applied to the image formation surface of the transfer member to which the reaction liquid is applied.

Reaction Liquid

The reaction liquid contains a component that increases the viscosity of the ink (also referred to as an ink viscosity increasing component). Here, the increasing of the viscosity of the ink means a case where a coloring material, a resin, and the like constituting the ink are brought into contact with the ink viscosity increasing component to chemically react therewith or to be physically adsorbed thereto, and an increase in viscosity of the entire ink is thus observed. In addition, the increasing of the viscosity of the ink is not limited to this case and also includes a case where some of ink compositions such as a coloring material aggregate to locally increase the viscosity. Here, the “reaction” in the “reaction liquid” also includes not only the occurrence of a chemical reaction with the ink but also the occurrence of a physical action (adsorption or the like). The ink viscosity increasing component has an effect of reducing fluidity of a part of the ink and/or the ink composition on the transfer member to suppress bleeding and beading during the image formation.

In the present exemplary embodiment, an acid is used as the ink viscosity increasing component, but a polyvalent metal ion or a porous fine particle can be also used as the ink viscosity increasing component. In addition, a plurality of types of the ink viscosity increasing components are preferably contained. A content of the ink viscosity increasing component in the reaction liquid is preferably 5% by mass or more with respect to a total mass of the reaction liquid.

Specific examples of an organic acid that can be used as the ink viscosity increasing component can include oxalic acid, polyacrylic acid, formic acid, acetic acid, propionic acid, glycolic acid, malonic acid, malic acid, maleic acid, ascorbic acid, levulinic acid, succinic acid, glutaric acid, glutamic acid, fumaric acid, citric acid, tartaric acid, lactic acid, pyrrolidone carboxylic acid, pyrone carboxylic acid, pyrrole carboxylic acid, furan carboxylic acid, pyridine carboxylic acid, coumarin acid, thiophene carboxylic acid, nicotinic acid, oxysuccinic acid, and dioxysuccinic acid. In addition, examples of an inorganic acid that can be used as the ink viscosity increasing component can include hydrochloric acid, phosphoric acid, sulfuric acid, nitric acid, and boric acid. These acids can be used alone or in combination of two or more thereof as the ink viscosity increasing component.

The reaction liquid may also contain an appropriate amount of water or an organic solvent. Water to be used in this case is preferably deionized water obtained by ion exchange or the like. A content of the water in the reaction liquid is preferably 50 to 85% by mass based on the total mass of the reaction liquid. In addition, the organic solvent that can be used for the reaction liquid is not particularly limited, and any known organic solvent can be used.

Various resins can be added to the reaction liquid. For example, in a case where an appropriate resin is added to the reaction liquid, adhesiveness of the ink image to the recording medium during transfer can be excellent or mechanical strength of a final image can be enhanced, which is preferable. A material to be used for the resin is not particularly limited as long as it can coexist with the ink viscosity increasing component. A material that can coexist with the ink viscosity increasing component may be selected from a resin and a resin fine particle that can be used for an ink described below.

In addition, the reaction liquid can be used by adding a surfactant or a viscosity modifier and adequately adjusting a surface tension and a viscosity thereof. Surface energy of the reaction liquid is adjusted to 50 mN/m or less, preferably 20 mN/m to 40 mN/m, and more preferably 20 mN/m or less.

A material to be used in this case is not particularly limited as long as it can coexist with the ink viscosity increasing component. A specific example of the surfactant to be used can include Megafac F-444 (trade name, manufactured by DIC Corporation), and in particular, a fluorine-based surfactant is preferably contained.

Here, the fluorine-based surfactant is a compound having at least a hydrophobic fluorocarbon chain and a hydrophilic molecular chain (hydrophilic moiety) in a molecular structure. The fluorine-based surfactant has the hydrophobic fluorocarbon chain, such that excellent surface tension reduction ability as described above is exhibited.

Among them, in particular, a nonionic surfactant having a fluoroalkyl chain at the hydrophobic moiety and an ethylene oxide chain at the hydrophilic moiety is preferably used. The surfactant has a fluoroalkyl chain at the hydrophobic moiety and an ethylene oxide chain at the hydrophilic moiety, such that compatibility with a solvent or a reaction agent is high, and excellent solubility is exhibited even in a composition in which a moisture content is reduced due to drying or the like. Therefore, uniformity and surface tension reduction ability of a reaction liquid layer can be kept.

In addition, when the surfactant is the nonionic surfactant, characteristics thereof can be maintained without a change in structure even after the reaction with the ink composition. Therefore, the uniformity and the surface tension reduction ability of the reaction liquid layer can be kept.

Examples of the fluorine-based surfactant preferably used in the present invention can include FSO100, FSN100, and FS3100 (trade name, manufactured by DuPont), and F444, F477, and F553 (trade name, manufactured by DIC Corporation). A content of the fluorine-based surfactant is preferably 1% by mass or more to 10% by mass or less with respect to the total mass of the reaction liquid.

Application of Reaction Liquid (Reaction Liquid Application Step)

Various methods known in the related art can be appropriately used in the reaction liquid applying step of applying the reaction liquid to the image formation surface of the transfer member. Specific examples of the method can include die coating, blade coating, a method using a gravure roller, a method using an offset roller, and spray coating. In addition, a method of applying a reaction liquid using an ink jet device is preferred. Furthermore, it is extremely preferable to combine a plurality of several methods.

Formation of Ink Image (Ink Applying Step)

The ink image is formed on the image formation surface of the transfer member in the ink applying step of applying the ink to the image formation surface of the transfer member to which the reaction liquid is applied. In the ink applying step, the ink is applied to the transfer member to be at least partially overlapped with a region where the reaction liquid is applied.

For example, an ink jet device can be used in the application of the ink. Examples of the ink jet device can include devices with the following modes:
a mode where the ink is discharged by causing film boiling in the ink to form air bubbles by an electrothermal transducer;
a mode where the ink is discharged by an electrothermal transducer; and
a mode where the ink is discharged by using static electricity.

As described above, any of various ink jet devices proposed for an ink jet liquid discharge technology can be used. Among them, in particular, an ink jet device with a mode using an electrothermal transducer is preferably used from the viewpoint of printing at a high speed and a high density.

In addition, the mode of the entire ink jet device is not particularly limited, and for example, it is possible to use the following ink jet heads:
an ink jet head in a form of a so-called shuttle where recording is performed while scanning the head perpendicular to a traveling direction of the transfer member; and
an ink jet head in a form of a so-called line head where ink discharge ports are linearly arranged substantially perpendicular to a traveling direction of the transfer member (that is, substantially in parallel with an axis direction in a case where the transfer member has a drum shape).

Ink

Hereinafter, each component that can be used in the ink will be described.

(1) Coloring Material

A coloring material in which a known dye or pigment is dissolved and/or dispersed can be used in the ink. Specifically, various pigments are suitable for exhibiting characteristics of durability and quality of a printed matter.

The ink can contain at least one of a pigment and a dye as the coloring material. The dye and the pigment are not particularly limited, and can be selected from materials that can be used as the coloring material of the ink and can be used in a required amount. For example, a dye, carbon black, or organic pigment known as an ink jet ink can be used. A coloring material obtained by dissolving and/or dispersing a dye and/or a pigment in a liquid medium can be used. Specifically, various pigments capable of implementing characteristics of durability and quality of a printed matter are preferred, and an ink containing at least a pigment as the coloring material is preferred. The pigment that can be used in the ink is not particularly limited, and a known inorganic pigment or organic pigment can be used. Specifically, a pigment represented by a color index (C.I.) number can be used. In addition, carbon black is preferably used as a black pigment.

A content of the dye and/or the pigment in the ink is preferably 0.5% by mass or more to 15.0% by mass or less, and more preferably 1.0% by mass or more to 10.0% by mass or less, with respect to a total mass of the ink.

(2) Pigment Dispersant

Any dispersant can be used as a pigment dispersant for dispersing a pigment as long as it is used in an ink jet ink known in the related art. Specifically, a water-soluble dispersant having both a hydrophilic moiety and a hydrophobic moiety in a molecular structure thereof is preferably used. In particular, a pigment dispersant formed of a resin obtained by copolymerizing at least a hydrophilic monomer and a hydrophobic monomer is preferably used. Each monomer to be used here is not particularly limited, and a monomer known in the related art is preferably used. Specific examples of the hydrophobic monomer can include styrene, a styrene derivative, alkyl (meth)acrylate, and benzyl (meth)acrylate. In addition, examples of the hydrophilic monomer can include acrylic acid, methacrylic acid, and maleic acid.

An acid value of the dispersant is preferably 50 mgKOH/g or more to 550 mgKOH/g or less. In addition, a weight average molecular weight of the dispersant is preferably 1,000 or more to 50,000 or less. A mass ratio of the pigment to the dispersant in the ink is preferably in a range of 1:0.1 to 1.3.

In addition, as another aspect of the ink, it is preferable to use a so-called self-dispersible pigment capable of being dispersed itself by surface-modification of a pigment itself without using a dispersant.

(3) Resin Fine Particle

The ink can contain various particles having no coloring material. Specifically, a resin fine particle is preferred due to its effect of improving image quality and fixability. A material of the resin fine particle is not particularly limited, and a known resin can be appropriately used. Specific examples of the material of the resin can include homopolymers such as polyolefin, polystyrene, polyurethane, polyester, polyether, polyurea, polyamide, polyvinyl alcohol, poly(meth)acrylic acid and a salt thereof, polyalkyl (meth)acrylate, and polydiene. Alternatively, an example of the material of the resin can include a copolymer obtained by copolymerizing a plurality of homopolymers in combination. A mass average molecular weight of the resin is preferably in a range of 1,000 or more to 2,000,000 or less. In addition, a content of the resin fine particle in the ink is preferably 1% by mass or more to 50% by mass or less, and more preferably 2% by mass or more to 40% by mass or less, with respect to the total mass of the ink.

Furthermore, the resin fine particle is preferably used as a resin fine particle dispersion dispersed in the ink. A dispersion method is not particularly limited, and a so-called self-dispersion type resin fine particle dispersion in which a resin obtained by homopolymerization of a monomer having a dissociable group or by copolymerization of a plurality of monomers is dispersed is preferred. Here, examples of the dissociable group can include a carboxyl group, a sulfonic acid group, and a phosphoric acid group, and examples of the monomer having the dissociable group can include acrylic acid and methacrylic acid. In addition, a so-called emulsion dispersion type resin fine particle dispersion in which resin fine particles are dispersed by an emulsifier can also be similarly and preferably used. A known surfactant having a low molecular weight or a high molecular weight is preferably used as the emulsifier mentioned here. The surfactant is preferably a nonionic surfactant or a surfactant having the same charge as that of the resin fine particle. A dispersion particle diameter of the resin fine particle dispersion is preferably 10 nm or more to 1,000 nm or less and more preferably 100 nm or more to 500 nm or less.

In addition, when the resin fine particle dispersion is produced, in order to stabilize the dispersion, various types of additives are preferably added thereto. As the additives, for example, n-hexadecane, dodecyl methacrylate, stearyl methacrylate, chlorobenzene, dodecyl mercaptan, olive oil, a blue dye (bluing agent: Blue 70), polymethyl methacrylate, and the like are preferred.

(4) Surfactant

The ink may also contain a surfactant. A specific example of the surfactant can include an Acetylenol EH (trade name, manufactured by Kawaken Fine Chemicals Co., Ltd.). A content of the surfactant in the ink is preferably 0.01% by mass or more to 5.0% by mass or less with respect to the total mass of the ink.

(5) Water and Water-Soluble Organic Solvent

The ink can contain water and/or a water-soluble organic solvent as a liquid medium. The water is preferably deionized water obtained by ion exchange or the like. An aqueous liquid medium including water or a mixture of water and a water-soluble organic solvent can be used as an aqueous ink liquid medium. An aqueous ink can be obtained by adding a coloring material to the aqueous liquid medium. A content of the water in the aqueous ink is preferably 30% by mass or more to 97% by mass or less, and more preferably 50% by mass or more to 95% by mass or less, with respect to the total mass of the ink. In addition, a type of the water-soluble organic solvent used in the ink is not particularly limited, and any known organic solvent can be used. Specific examples of the water-soluble organic solvent can include glycerin, diethylene glycol, polyethylene glycol, and 2-pyrrolidone. In addition, a content of the water-soluble organic solvent in the ink is preferably 3% by mass or more to 70% by mass or less with respect to the total mass of the ink.

(6) Other Additives

The ink may also contain various additives such as a pH adjuster, a rust preventive, a preservative, a mildew-proofing agent, an antioxidant, an anti-reducing agent, a water-soluble resin and a neutralizing agent thereof, and a viscosity adjuster, in addition to the above components, if necessary.

Transfer of Ink Image (Transfer Step)

After the formation of the ink image, in a transfer step, the image formation surface of the transfer member having the ink image is pressed against the recording medium to transfer the ink image to the recording medium, thereby obtaining a final image. The term “recording medium” in the present specification refers to not only paper used in general printing widely but also a fabric, plastic, a film, other printing media, and a recording media.

A method of pressing the transfer member against the recording medium is not particularly limited, and a method of pressurizing the transfer member and the recording medium using a pair of pressing rollers is preferably used to efficiently transfer and form an image. In addition, the pressurization is preferably applied stepwise because it is also effective to reduce transfer failures in some cases.

Liquid Component Removing Step

A step of reducing a liquid component from the ink image formed on the image formation surface of the transfer member (liquid component removing step) is preferably provided. When the liquid component of the ink image is excessive, an excessive liquid protrudes or overflows in the transfer step, which results in image disturbance and transfer failures. Any of various methods used in the related art can be preferably used as a method of removing the liquid component from the ink image. For example, any of a method by heating, a method of blowing low-humidity air, a pressure reduction method, a method of contacting an absorber, and a method obtained by combining these methods is preferably used. In addition, a method performed by natural drying can be used.

Heating Step

A heating step of heating the ink image formed on the image formation surface of the transfer member may be provided as a heating step that is the next step of the ink applying step.

Examples of a heating device used in the heating step can include a heating device by heat generation, such as a heater, and a heating device by irradiation with infrared light or near-infrared light.

The heating step may also serve as the liquid component removing step described above.

In a case of the ink image of which transferability is improved by heating, the ink image is preferably transferred by heating the ink image and pressing the ink image against the recording medium in the transfer step in a state where a temperature (transfer temperature) is kept at a suitable temperature for transfer.

The heating temperature is preferably 70° C. or higher and 120° C. or lower from the viewpoint of improving transferability by heating of the ink image and durability of the transfer member by heating.

In addition, in a case where the ink jet recording method includes the heating step, the transfer member is preferably used for heat transfer.

Cleaning Step

As described above, in an example of the ink jet recording method of the present invention, the reaction liquid is applied, the ink image is formed and transferred by applying the ink, and if necessary, the liquid component added from the ink image is removed, thereby completing the image formation. However, the transfer member is repeatedly and continuously used from the viewpoint of productivity. In this case, a cleaning step of cleaning the image formation surface before formation of the subsequent ink image is preferably performed. Any of various methods used in the related art can be preferably applied as a method of cleaning the image formation surface of the transfer member. For example, it is possible to preferably use any of the following methods:
a method of applying a cleaning liquid to the surface of the transfer member in a shower manner;
a method of abutting a molleton roller wetted with the cleaning liquid against the surface of the transfer member to wipe the surface of the transfer member;
a method of bringing the surface of the transfer member into contact with a cleaning liquid surface;
a method of scrapping off the surface of the transfer member with a wiper blade; and
a method of applying various energies to the surface of the transfer member.

In addition, a method performed by combining a plurality of these methods is also preferred.

The method of applying the cleaning liquid to the surface of the transfer member in a shower manner is more preferred from the viewpoint of dissolving and completely removing the reaction liquid and ink residues, and is also preferred in that the image formation surface is not damaged by mechanical contact like the wiper blade.

Fixing Step

The ink jet recording method may include a fixing step of heating and pressurizing the recording medium on which the image is recorded after transfer to improve fixability of the recording medium and the image.

Ink Jet Recording Apparatus

The ink jet recording apparatus according to the present invention includes an image forming unit and a transfer unit. The image forming unit includes a reaction liquid applying device applying a reaction liquid containing a component that increases a viscosity of an ink to an image formation surface of a transfer member, and an ink applying device applying an ink to the image formation surface of the transfer member to form an ink image. In addition, the reaction liquid applying device may include a reaction liquid storage storing the reaction liquid. In addition, the ink applying device may include an ink storage storing the ink.

Furthermore, the ink jet recording apparatus according to the present invention may further include a heating device that heats the ink image at a temperature for transferring the ink image to the recording medium.

FIG. 2 is a schematic view illustrating a schematic configuration of an ink jet recording apparatus according to an exemplary embodiment of the present invention.

The ink jet recording apparatus in FIG. 2 includes a transfer member 11 supported by a support member 12, a reaction liquid applying device 14, an ink applying device 15, an air-blowing device (liquid component removing device) 16, a heating device 17, a pressing roller (pressing member) 19, and a cleaning unit 20.

The transfer member having the configuration illustrated in FIG. 1 is used as the transfer member 11.

In FIG. 2, the transfer member 11 is arranged on an outer circumferential surface of the rotatable drum-shaped support member 12. The transfer member 11 is rotatably driven about a rotation axis 13 in an arrow direction, and respective devices circumferentially arranged are operated in synchronization with the rotation of the transfer member, to form a final image on a recording medium by formation and transfer of an ink image. When the drum-shaped transfer member 11 of the present exemplary embodiment is used, the same transfer member 11 is easily continuously and repeatedly used and an extremely suitable configuration is provided also in terms of productivity. The image forming unit of the present exemplary embodiment includes the reaction liquid applying device 14 and the ink applying device 15. A reaction liquid applying device having a roll coater is provided as the reaction liquid applying device 14 (14a: reaction liquid, 14b and 14c: reaction liquid applying rollers). An ink jet device provided with an ink jet recording head is provided as the ink applying device. These devices are sequentially arranged from the upstream to the downstream in a rotation direction of the transfer member 11, and the reaction liquid is applied to the image formation surface of the transfer member 11 before the application of the ink.

The ink jet device may have a plurality of ink jet recording heads. For example, in a case where color images are formed using a yellow ink, a magenta ink, a cyan ink, and a black ink, the ink jet device has four ink jet recording heads that discharge the respective four types of inks onto the transfer member.

The air-blowing device 16 is provided for a liquid removing treatment that blows air to an ink image to remove at least a part of the liquid component from the ink image.

The heating device 17 may be a heater provided in the support member 12, and the ink image can be heated from a region closer to the image formation surface of the transfer member 11 by the heating device 17.

A pair of pressing rollers for transfer are formed by the pressing roller 19 and the drum-shaped support member 12. A recording medium 18 can be allowed to pass through a nip portion formed by contact of an outer circumferential surface of the pressing roller 19 with the outer circumferential surface of the drum-shaped support member 12 while being overlapped with the image formation surface of the transfer member 11 on which the ink image is formed, thereby pressing and transferring the ink image against and to the recording medium 18. A temperature at the time of transfer is applied by the heating device 17. In the present exemplary embodiment, the transfer unit is formed by the pressing roller 19 as a pressing member for transfer and the support member 12 of the transfer member 11.

In a case where the transfer member 11 is repeatedly and continuously used, the cleaning unit 20 (20a: cleaning liquid, 20b and 20c: cleaning rollers) is used to clean the surface of the transfer member 11 for formation of the subsequent ink image. In the present exemplary embodiment, the cleaning unit is provided to clean the image formation surface by abutting the wetted molleton roller against the image formation surface of the transfer member to wipe the image formation surface.

According to the present invention, it is possible to provide a transfer member having improved image formability, transferability, and cleanability during repeated use, an ink jet recording method, and an ink jet recording apparatus.

### EXAMPLES

Hereinafter, the present invention will be described in more detail by using Examples and Comparative Examples. The present invention is not limited to the following Examples without departing from the gist thereof. In addition, “%” and “part(s)” in the context are based on a mass, unless otherwise indicated. In order to distinguish materials for a surface of a produced transfer member, an alphabet is assigned to each of surface layers.

### Example 1

A transfer member has a layer structure illustrated in FIG. 1 was produced by stacking a first reinforcement layer 104, a compression layer 103, a second reinforcement layer (not illustrated), an elastic layer 102, and a surface layer 101 in this order. Here, the first reinforcement layer 104 is formed of one cotton woven fabric having a thickness of 2.0 mm, the compression layer 103 is formed of porous acrylonitrile-butadiene rubber having a thickness of 1.0 mm, and the second reinforcement layer is formed of a polyethylene terephthalate (PET) film having a thickness of 0.05 mm. Each of the elastic layer and the surface layer of the transfer member was produced as follows.

Elastic Layer

A material (polyorganosiloxane) for silicone rubber formation was stacked on the compression layer 103 with the second reinforcement layer formed of the polyethylene terephthalate (PET) film having the thickness of 0.05 mm interposed between the material and the compression layer 103, and the material was subjected to vulcanization, thereby obtaining an elastic layer formed of silicone rubber. A thickness of the elastic layer was 0.20 mm.

Surface Layer

Preparation of Coating Liquid A Used in Production of Surface Layer a Dimethyldiethoxysilane, glycidoxypropyldiethoxysilane, triethoxy-1H,1H,2H,2H-tridecafluoro-n-octylsilane were mixed at a molar ratio of 59:40:1 to obtain a hydrolyzable organosilane compound. Thereafter, water was added in an amount of 2.4 mole equivalent with respect to a total number of moles of the hydrolyzable organosilane compound, acetic acid as a catalyst was added in an amount of 500 ppm with respect to a total weight of the hydrolyzable organosilane compound, and heating reflux was performed at 100° C. for 24 hours. Therefore, a solution containing an organosiloxane compound obtained by dehydrating and condensing the hydrolyzable organosilane compound was obtained. The solution was diluted with an ethanol/methyl isobutyl ketone mixed solvent (weight ratio of 4/1) so that a content of the organosiloxane compound (a) was 35% by mass. 1,5-Pentanediol as a flexible component was added in an amount of 10 mol % with respect to the number of moles of the organosiloxane compound. In addition, a photo cationic polymerization initiator CPI-410S (trade name, manufactured by San-Apro Ltd.) was added in an amount of 3 mol % with respect to the number of moles of the organosiloxane compound, thereby preparing a coating liquid A.

Formation of Surface Layer

An elastic layer subjected to a plasma surface treatment was spin coated using the coating liquid A to form a film. Next, the film was exposed by irradiation with a UV lamp (trade name: FUSION LIGHT HAMMER, manufactured by Alpha UV Systems, peak wavelength: 365 nm), heated at 150° C. for 2 hours, and then cured, thereby forming a surface layer. The surface layer having a thickness of 5 μm was formed by controlling the number of rotations in the spin coating, thereby obtaining a surface layer a.

Measurement of Swelling Rate of Surface Layer of Transfer Member

A swelling rate of the surface layer of the transfer member by 1,2-hexanediol was calculated based on the amount of change in the thickness of the surface layer before and after swelling (before and after immersion) after immersing the transfer member in a 10% 1,2-hexanediol aqueous solution for 12 hours (the following equation). The measurement was performed by a non-contact spectroscopic interference method using an Optical NanoGauge film thickness meter (mode: C13027, manufactured by Hamamatsu Photonics K.K.).

Swelling rate [%]=((thickness of surface layer after immersion)/(initial thickness (before immersion) of surface layer)−1)×100

Measurement of Storage Elastic Modulus of Surface Layer of Transfer Member

A storage elastic modulus of the surface layer of the transfer member may be measured by either a method of measuring a storage elastic modulus of the surface layer of the transfer member or a method of producing a surface layer on a separate silicon wafer and measuring a storage elastic modulus of the surface layer. In the present example, in order to measure a more accurate value, a surface layer was produced on a separate silicon wafer, and a storage elastic modulus of the surface layer was measured. The coating liquid A used in the production of the surface layer of the transfer member was applied onto the silicon wafer by spin coating, exposed by irradiation with a UV lamp, heated at 150° C. for 2 hours, and then cured, thereby obtaining a surface layer having a thickness of 5 The measurement was performed using a TI950 TriboIndenter (manufactured by Hysitron, Inc) with a Berkovich type diamond indentor under conditions of a load of 40 μN, a frequency of 150 Hz, and room temperature.

Formation of Image

The transfer member obtained by the above method was evaluated for items described below using the transfer type ink jet recording apparatus illustrated in FIG. 2. A cylindrical drum formed of an aluminum alloy was used as the support member of the transfer member.

A reaction liquid of the following composition was continuously applied to the surface of the transfer member using a roller type application device. In the present example, citric acid was used as an organic acid.
Citric acid: 20.0 parts
Glycerin: 5.0 parts
Megafac F-444 (trade name, manufactured by DIC Corporation): 1.0 part
Ion exchange water: 74.0 parts

Subsequently, an ink for image formation was discharged from an ink jet device to the image formation surface of the transfer member to form an ink image (mirror reversed image) on the transfer member. A 100% solid image pattern in which a solid image having a recording duty of 100% was formed in a range of 1 cm×1 cm was used in a discharge pattern of the ink image. In the present image recording apparatus, a condition in which 3.0 ng of one ink droplet was applied to a unit area of 1/1,200 inch× 1/1,200 inch by a resolution of 1,200 dpi×1,200 dpi was defined as the 100% recording duty. A device for performing ink discharge using an electrothermal transducer in an on-demand system was used as the ink jet device. A resin dispersion type pigment ink of the following composition was used as the ink.
C.I. Pigment Blue 15:3:3.0 parts
Styrene-acrylic acid-ethyl acrylate copolymer (acid value: 240, weight average molecular weight: 50,000): 1.0 part
Glycerin: 10.0 parts
Ethylene glycol: 5.0 parts
Acetylenol E100 (trade name, manufactured by Kawaken Fine Chemicals Co., Ltd.): 0.5 parts
1,2-Hexanediol: 0.5 parts
Ion exchange water: 80 parts

Coated paper (trade name: Aurora Coat, manufactured by Nippon Paper Industries Co., Ltd., basis weight: 73.5 g/m²) was used as a recording medium, and an ink image was pressure-bonded and transferred to the recording medium, thereby forming a final image. The transfer was performed at a rate of 1.0 m/sec 50,000 times. Cleaning in this case was performed by a method of abutting a molleton roller wetted with a 20% 1,2-hexanediol solution against the surface of the transfer member to wipe the surface of the transfer member.

### Examples 2 to 9 and Comparative Examples 1 to 5

As shown in Table 1, in Examples 2 to 9 and Comparative Examples 1 to 3, surface layers b to 1 of transfer bodies were produced in the same manner as that of Example 1 by using the following coating liquids B to L instead of the coating liquid A, and the evaluation was performed using the transfer type ink jet recording apparatus illustrated in FIG. 2. In addition, in Comparative Example 4, the evaluation was performed using a transfer member in which an elastic layer itself was a surface layer without providing the surface layer on the elastic layer. Furthermore, in Comparative Example 5, the evaluation was performed using a transfer member including a surface layer formed of butadiene rubber on the elastic layer.

Preparation of Coating Liquid B and Formation of Surface Layer b A coating liquid B was prepared in the same manner as in the preparation of the coating liquid A, except that 1,6-hexanediol as a flexible component was mixed in an amount of 10 mol % with respect to the number of moles of the organosiloxane compound, and a surface layer was formed in the same manner as that of the surface layer a, thereby obtaining a surface layer b.

Preparation of Coating Liquid C and Formation of Surface Layer c A coating liquid C was prepared in the same manner as in the preparation of the coating liquid A, except that 1-butene-1,4-diol as a flexible component was mixed in an amount of 10 mol % with respect to the number of moles of the organosiloxane compound, and a surface layer was formed in the same manner as that of the surface layer a, thereby obtaining a surface layer c.

Preparation of Coating Liquid D and Formation of Surface Layer d A coating liquid D was prepared in the same manner as in the preparation of the coating liquid A, except that 2-pentene-1,5-diol as a flexible component was mixed in an amount of 10 mol % with respect to the number of moles of the organosiloxane compound, and a surface layer was formed in the same manner as that of the surface layer a, thereby obtaining a surface layer d.

Preparation of Coating Liquid E and Formation of Surface Layer e A coating liquid E was prepared in the same manner as in the preparation of the coating liquid A, except that 2-hexene-1,6-diol as a flexible component was mixed in an amount of 10 mol % with respect to the number of moles of the organosiloxane compound, and a surface layer was formed in the same manner as that of the surface layer a, thereby obtaining a surface layer e.

Preparation of Coating Liquid F and Formation of Surface Layer f A coating liquid F was prepared in the same manner as in the preparation of the coating liquid A, except that 1,3-butadiene-1,4-diol as a flexible component was mixed in an amount of 10 mol % with respect to the number of moles of the organosiloxane compound, and a surface layer was formed in the same manner as that of the surface layer a, thereby obtaining a surface layer f.

Preparation of Coating Liquid G and Formation of Surface Layer g A coating liquid G was prepared in the same manner as in the preparation of the coating liquid A, except that 1,3-pentadiene-1,5-diol as a flexible component was mixed in an amount of 10 mol % with respect to the number of moles of the organosiloxane compound, and a surface layer was formed in the same manner as that of the surface layer a, thereby obtaining a surface layer g.

Preparation of Coating Liquid H and Formation of Surface Layer h

A coating liquid H was prepared in the same manner as in the preparation of the coating liquid A, except that 2,4-hexadiene-1,6-diol as a flexible component was mixed in an amount of 10 mol % with respect to the number of moles of the organosiloxane compound, and a surface layer was formed in the same manner as that of the surface layer a, thereby obtaining a surface layer h.

Preparation of Coating Liquid I and Formation of Surface Layer i A coating liquid I was prepared in the same manner as in the preparation of the coating liquid A, except that 2,4-hexadiene-1,6-diol as a flexible component was mixed in an amount of 30 mol % with respect to the number of moles of the organosiloxane compound, and a surface layer was formed in the same manner as that of the surface layer a, thereby obtaining a surface layer i.

Preparation of Coating Liquid J and Formation of Surface Layer j A coating liquid J was prepared in the same manner as in the preparation of the coating liquid A, except that 1,4-butanediol as a flexible component was mixed in an amount of 10 mol % with respect to the number of moles of the organosiloxane compound, and a surface layer was formed in the same manner as that of the surface layer a, thereby obtaining a surface layer j.

Preparation of Coating Liquid K and Formation of Surface Layer k A coating liquid K was prepared in the same manner as in the preparation of the coating liquid A, except that a Denacol EX-830 (trade name, manufactured by Nagase ChemteX Corporation) as a flexible component was mixed in an amount of 10 mol % with respect to the number of moles of the organosiloxane compound. Subsequently, a surface layer was formed in the same manner as that of the surface layer a, thereby obtaining a surface layer k. The Denacol EX-830 is a flexible component having epoxy groups at both terminals thereof and an ethylene glycol chain at the center thereof.

Preparation of Coating Liquid L and Formation of Surface Layer l

A KF105 (trade name, manufactured by Shin-Etsu Chemical Co., Ltd.) as a silicone resin was diluted with methyl isobutyl ketone so that a content thereof was 35% by mass. Then, a photo cationic polymerization initiator CPI-410S (trade name, manufactured by San-Apro Ltd.) was added in an amount of 3 mol % with respect to the number of moles of the organosiloxane compound, thereby preparing a coating liquid L. A surface layer was formed in the same manner as that of the surface layer a, thereby obtaining a surface layer l having a high strength silicone resin.

Formation of Surface Layer m

Silicone rubber was used as the elastic layer and the evaluation was performed without providing a new surface layer on the elastic layer. A surface layer of the silicone rubber in this case was a surface layer m.

Formation of Surface Layer n

A 0.1 mm butadiene rubber was attached to the elastic layer to produce a transfer member including a surface layer n.

Hereinafter, in Table 1, the surface layers used in Examples 1 to 9 and Comparative Examples 1 to 5 are indicated by the alphabets, and a swelling rate and a storage elastic modulus of each of the surface layers are shown. In addition, for evaluation of the surface layers used in Examples 1 to 9 and Comparative Examples 1 to 5, abrasion resistance, image formability, transferability, and cleanability were evaluated. The evaluation was performed according to the following criteria. Regarding Comparative Example 3, the following evaluation was not performed because cracks occurred in the produced surface layer 1. In addition, in Comparative Example 5, since the constituent materials of the surface layer were denatured due to 1,2-hexanediol, the swelling rate of the surface layer could not be measured.

Abrasion Resistance Evaluation

For abrasion resistance evaluation of the surface layer, the surface layer was repeatedly subjected to abrasion with a Gakushin tester (manufactured by Imoto Machinery Co., Ltd.), and a state of the surface layer after abrasion was observed and evaluated. The abrasion was performed by pressing a Toraysee PW (trade name, manufactured by TORAY INDUSTRIES, INC.) sheet against the surface layer of the transfer member at a load of 200 g and performing a reciprocating movement 1,000 times. The evaluation was performed according to the following criteria.

A: There is no surface change due to abrasion, or abrasion marks due to abrasion remain on a part of the surface, but the surface is not scraped.

B: Abrasion marks due to abrasion remain on the entire surface, but the surface is not scraped.

C: The surface is scraped due to abrasion.

Image Formability Evaluation

For evaluation of image formability after undergoing a repeated image formation process, image formability after performing image formation 1,000 times was evaluated. Specifically, the image formation, transfer, and cleaning described above were repeated 1,000 times, only image formation was performed, and then the image quality of the ink image was evaluated. The evaluation was performed according to the following criteria.

A: The reaction liquid was uniformly applied without repelling, and a high-quality ink image was favorably formed.

B: Repelling of the reaction liquid was slightly observed, but the image quality of the ink image was sufficient.

C: Repelling of the reaction liquid was observed, and the image quality of a part of the ink image was not sufficient.

Transferability Evaluation

In the image formability evaluation, a state of the surface of the transfer member immediately after the ink image used for the evaluation was transferred to the recording medium and before the transfer member was cleaned was visually observed to evaluate the transferability. The evaluation was performed according to the following criteria.

A: No ink image residue was observed on the transfer member and the final image was favorably formed.

B: The ink image residue was slightly observed on the transfer member, but the image quality of the final image was sufficient.

C: A somewhat ink image residue was observed on the transfer member, and a part of the final image was not sufficiently transferred.

Cleanability Evaluation

In the image formability evaluation, a state of the surface of the transfer member after the ink image used for the evaluation was transferred to the recording medium and then the surface of the transfer member was cleaned was visually observed to evaluate the cleanability. The evaluation was performed according to the following criteria.

A: No ink residue or cleaning liquid residue was observed on the surface of the transfer member after cleaning.

B: The ink residue or cleaning liquid residue was slightly observed on the surface of the transfer member after cleaning, but it did not affect the subsequent image formation.

C: The ink residue or cleaning liquid residue was observed on the surface of the transfer member after cleaning, but it affected the subsequent image formation.

TABLE 1

| | | | Flexible group | | | | | Evaluation after performing | | |
|---|---|---|---|---|---|---|---|---|---|---|
| | | | | Number of | Swelling | Elastic | Abrasion | image formation 1,000 times | | |
| | Surface | Base | Number of | double | rate | modulus | resistance | Image | Transfer- | Clean- |
| | layer | resin | carbons | bonds | [%] | [MPa] | evaluation | formability | ability | ability |
| Example 1 | a | Silicone | 5 | 0 | 1 | 230 | A | A | A | B |
| Example 2 | b | | 6 | 0 | 3 | 200 | A | B | A | B |
| Example 3 | c | | 4 | 1 | 1 | 250 | A | A | A | A |
| Example 4 | d | | 5 | 1 | 2 | 220 | A | B | A | B |
| Example 5 | e | | 6 | 1 | 4 | 170 | A | B | A | B |
| Example 6 | f | | 4 | 2 | 2 | 160 | A | B | A | B |
| Example 7 | g | | 5 | 2 | 3 | 120 | A | B | A | B |
| Example 8 | h | | 6 | 2 | 4 | 70 | A | B | A | B |
| Example 9^{a} | i | | 6 | 2 | 5 | 30 | A | B | A | B |
| Comparative | j | | 4 | 0 | 5 | 280 | A | B | C | B |
| Example 1 | | | | | | | | | | |
| Comparative | k | | — | — | 6 | 100 | A | C | A | C |
| Example 2^{b} | | | | | | | | | | |
| Comparative | l | | — | — | 1 | 1000 | — | — | — | — |
| Example 3^{c} | | | | | | | | | | |
| Comparative | m | Silicone | — | — | 1 | 5 | C | C | A | B |
| Example 4 | | rubber | | | | | | | | |
| Comparative | n | Butadiene | — | — | —^{d} | 30 | B | C | C | C |
| Example 5 | | rubber | | | | | | | | |

^{a}30% flexible group was added.
^{b}Ethylene oxide was used as flexible group.
^{c}High strength silicone resin was used.
^{d}Material denaturation occurred due to solvent.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-011007, filed Jan. 27, 2020, and Japanese Patent Application No. 2020-213731, filed Dec. 23, 2020, which are hereby incorporated by reference herein in their entirety.

What is claimed is:

1. A transfer member comprising:
a base layer and a surface layer,
wherein a swelling rate of the surface layer by 1,2-hexanediol is 5% or less, and
a storage elastic modulus of the surface layer is 30 MPa or more to 250 MPa or less.

2. The transfer member according to claim 1, wherein the surface layer contains a condensate of a hydrolyzable organosilane compound.

3. The transfer member according to claim 2, wherein the condensate of the hydrolyzable organosilane compound has a hydrocarbon group represented by the following General Formula (3),
—(CₙH₍₂ₙ₋ₘ₎)ₚ— (3)
wherein n represents an integer of 1 to 7, m represents an integer of 0 to 2, and p represents an integer of 1 to 120.

4. The transfer member according to claim 1, wherein the transfer member is used for heat transfer.

5. The transfer member according to claim 1, wherein the swelling rate of the surface layer by the 1,2-hexanediol is 3% or less.

6. An ink jet recording method comprising:
applying a reaction liquid containing a component that increases a viscosity of an ink to an image formation surface of a transfer member;
applying an ink to the image formation surface of the transfer member to form an ink image; and
transferring the ink image from the transfer member to a recording medium,
wherein the transfer member includes a base layer and a surface layer,
a swelling rate of the surface layer by 1,2-hexanediol is 5% or less, and
a storage elastic modulus of the surface layer is 30 MPa or more to 250 MPa or less.

7. The ink jet recording method according to claim 6, further comprising heating the ink image at a temperature for transferring the ink image to the recording medium.

8. An ink jet recording apparatus comprising:
an image forming unit that includes a reaction liquid applying device applying a reaction liquid containing a component that increases a viscosity of an ink to an image formation surface of a transfer member, and an ink applying device applying an ink to the image formation surface of the transfer member to form an ink image; and
a transfer unit that transfers the ink image from the transfer member to a recording medium,
wherein the transfer member includes a base layer and a surface layer,
a swelling rate of the surface layer by 1,2-hexanediol is 5% or less, and
a storage elastic modulus of the surface layer is 30 MPa or more to 250 MPa or less.

9. The ink jet recording apparatus according to claim 8, further comprising a heating device that heats the ink image at a temperature for transferring the ink image to the recording medium.
